(19) United States
(12) Patent Application Publication
(10) Pub. No.: US 2024/0242101 A1
(43) Pub. Date: Jul. 18, 2024

(54) HANDOVER OF DEEPLY NESTED QUERIES FOR QUANTUM COMPUTATION

(71) Applicant: Red Hat, Inc., Raleigh, NC (US)

(72) Inventors: Leigh Griffin, Waterford (IE); Stephen Coady, Waterford (IE)

(21) Appl. No.: 18/155,792

(22) Filed: Jan. 18, 2023

(51) Int. Cl. G06N 10/40; G06N 10/80

(52) U.S. Cl. CPC G06N 10/40; G06N 10/80

(57) ABSTRACT

Handover of deeply nested queries for quantum computation is disclosed. In one example, a processor device of a computing system implements a query handover service that performs handover of deeply nested queries for quantum computation. The query handover service can detect when a query received by the classical computing system is so deeply nested that it will be challenging for the classical computing system to execute within certain computational constraints. Upon detection of such a query, the query handover service can handover execution of the query to a quantum computing system.

### BACKGROUND

Quantum computing involves the use of quantum bits, referred to herein as “qubits,” which have characteristics that differ from those of classical (i.e., non-quantum) bits used in classical computing. Qubits may be employed by quantum services that are executed by quantum computing devices. As quantum computing continues to increase in popularity and become more commonplace, an ability to efficiently and accurately implement quantum computing will be desirable.

### SUMMARY

The examples disclosed herein implement a query handover service that performs handover of deeply nested queries for quantum computation. In particular, the query handover service can be implemented by or alongside a classical computing system that implements an application programming interface (API) query language that provides access to a plurality of resources. The query handover server can detect when a query received by the classical computing system is so deeply nested that it will be challenging for the classical computing system to execute within certain computational constraints. Upon detection of such a query, the query handover service can handover execution of the query to a quantum computing system. In particular, the query handover service can generate a quantum instruction set that both provides a mapping of the plurality of resources to a plurality of qubits of the quantum computing system and also encodes the API query language operations to be applied at each level of nesting. The query handover service can receive an execution path generated by the quantum computing system based on the quantum instruction set. The classical computing system can determine a result based on the execution path and can return the result in response to the query.

In one example, a method for handover of deeply nested queries for quantum computation is disclosed. The method comprises receiving a query expressed in an application programming interface (API) query language that provides access to a plurality of resources, wherein the query comprises a plurality of requested API operations that are nested within each other. The method comprises determining whether the query satisfies one or more query computation constraints. The method comprises, in response to the query satisfying the one or more query computation constraints: providing, to a quantum computing system comprising a plurality of qubits, a quantum instruction set that describes a mapping between the plurality of qubits and the plurality of resources; receiving, from the quantum computing system, an execution path that is responsive to the query and determined based on execution of the quantum instruction set; and returning, as a response to the query, a result from the plurality of resources based on the execution path received from the quantum computing system.

In another example, a computer system for handover of deeply nested queries for quantum computation is disclosed. The computer system comprises a system memory, and one or more processor devices communicatively coupled to the system memory. The one or more processor devices are to receive a query expressed in an application programming interface (API) query language that provides access to a plurality of resources, wherein the query comprises a plurality of requested API operations that are nested within each other. The one or more processor devices are to determine whether the query satisfies one or more query computation constraints. In response to the query satisfying the one or more query computation constraints, the one or more processor devices are to: provide, to a quantum computing system comprising a plurality of qubits, a quantum instruction set that describes a mapping between the plurality of qubits and the plurality of resources; receive, from the quantum computing system, an execution path that is responsive to the query and determined based on execution of the quantum instruction set; and return, as a response to the query, a result from the plurality of resources based on the execution path received from the quantum computing system.

In another example, a non-transitory computer-readable medium is disclosed. The non-transitory computer-readable medium stores thereon computer-executable instructions that, when executed, cause one or more processor devices to receive a query expressed in an application programming interface (API) query language that provides access to a plurality of resources, wherein the query comprises a plurality of requested API operations that are nested within each other. The one or more processor devices are to determine whether the query satisfies one or more query computation constraints. In response to the query satisfying the one or more query computation constraints, the one or more processor devices are to: provide, to a quantum computing system comprising a plurality of qubits, a quantum instruction set that describes a mapping between the plurality of qubits and the plurality of resources; receive, from the quantum computing system, an execution path that is responsive to the query and determined based on execution of the quantum instruction set; and return, as a response to the query, a result from the plurality of resources based on the execution path received from the quantum computing system.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing system in which examples may be practiced;

FIGS. 2A and 2B are flowcharts illustrating operations performed by the computing system of FIG. 1 for handover of deeply nested queries for quantum computation, according to one example;

FIG. 3 is a simpler block diagram of the quantum computing device of FIG. 1 for handover of deeply nested queries for quantum computation, according to one example;

FIG. 4 is a flowchart of a simplified method for handover of deeply nested queries for quantum computation by the quantum computing device of FIG. 3, according to one example; and

FIG. 5 is a block diagram of a quantum computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first executing quantum service” and “second executing quantum service,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Quantum computing involves the use of quantum bits, referred to herein as “qubits,” which have characteristics that differ from those of classical (i.e., non-quantum) bits used in classical computing. Qubits may be employed by quantum services that are executed by quantum computing devices.

Application programming interfaces (APIs) are a common way for a server computing system to enable various client devices or systems to request access to or retrieve results computed from a plurality of resources associated with the server computing system. Specifically, a client can transmit a query to the server, where the query is structured according to an API query language. The server can perform the set of operations requested by the query to retrieve or return a result to the client from the plurality of resources.

However, many API technologies suffer from an inability to process and return results from deeply nested API queries (e.g., queries that include requested API operations that are nested within each other). Specifically, the computational challenge associated with processing API queries grows exponentially for each level of nesting included in the nesting. Thus, queries with a significant level of nesting can quickly become problematic for a standard API system to process under typical computational constraints (e.g., typical processor capability, available memory levels, etc.). As such, the use of deeply nested API queries can result in a server computing system using excessive computational resources or failing to compute a result.

The examples disclosed herein implement a query handover service that performs handover of deeply nested queries for quantum computation. The query handover service can detect when the level of nesting associated with a query becomes problematic (e.g., requires processing or other actions that exceed one or more predefined computational constraints). In response the query handover server can generate a quantum instruction set that enables the query to instead be processed by a quantum computing system.

Specifically, the resources that are protected by a classical computing system (e.g., a server computing system as described above) are capable of being mapped to qubits of the quantum computing system, which in turn can be placed in superposition. Therefore, when the query handover service detects that a query is beyond the nested capability of the classical computing system, the query handover service will failover to a quantum computing system which is passed a quantum instruction set (e.g., QASM file) that has had its qubit allocation and mapping automatically generated from the resources under protection.

Each resource being mapped to a qubit allows the query handover service to encode an algorithmic mapping of the requested API logic into the quantum instruction set. Then, by executing the quantum instruction set, the quantum computing system can ultimately discover the energy minimum or optimal execution path through the resources.

The execution path discovered by the quantum computing system can then be provided back to classical computing system. The classical computing system can use the execution path to determine a result for the query and, then to return the result to the client that submitted the query.

The proposed approach therefore limits the need to perform deeply nested combinatorial work in a classical computing system and instead returns the correct resource by substituting the search and discovery with a superposition run performed by a quantum computing system. The proposed query handover service can therefore reduce the number of instances in which a classical computing system uses excessive computational resources or fails to compute or return a result to a query. Therefore, the proposed techniques improve the functionality of a computing system.

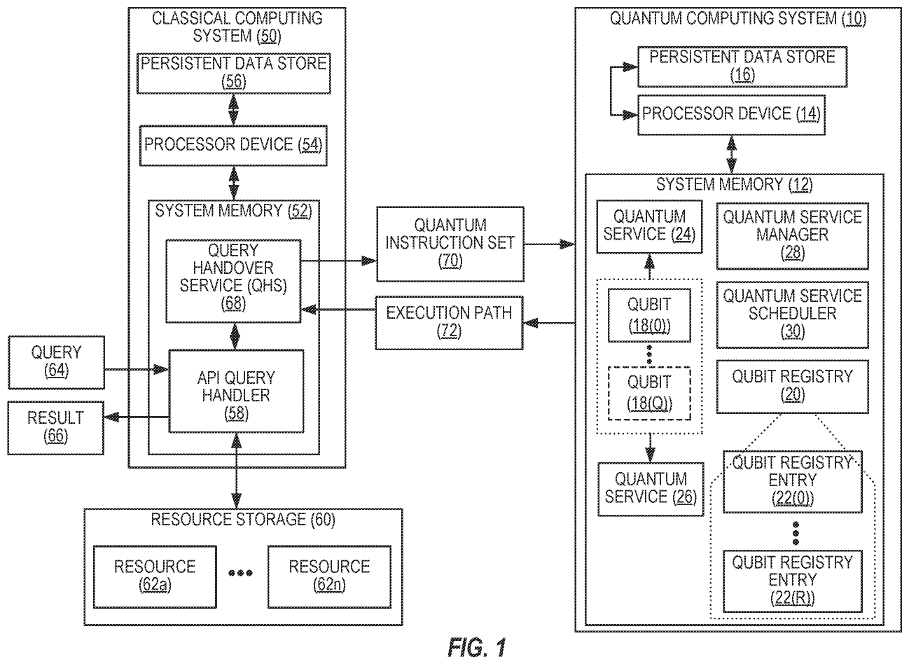

FIG. 1 is a block diagram of a computing environment that includes a classical computing system 50 and a quantum computing system 10. The classical computing system 50 comprises a system memory 52 and a processor device 54. The classical computing system 50 further comprises a persistent data store 56 (e.g., a hard drive or Solid State Drive (SSD), as non-limiting examples). It is to be understood that the classical computing system 50 in some examples may include constituent elements in addition to those illustrated in FIG. 1.

The system memory 52 includes an API query handler 58. The API query handler 58 can receive and process queries that are structured according to an API query language. For example, the API query handler 58 can receive a query 64 structured according to an API query language. The API query language can include a specification or set of rules for how to implement an API. One example API query language is the GraphQL data query language.

The API query handler 58 can process queries that request a result to be computed or otherwise returned from a plurality of resources. The plurality of resources can be held in a resource storage 60. As shown, the plurality of resources can include resources 62a-62n. The resources 62a-62n can include database entries, text representations of objects (e.g., programmatic objects), images, data files (e.g., code such as executables), and/or other resources. In some implementations, the resources 62a-62n can be structured in or according to a graph data structure or other hierarchical data structure.

Thus, the API query language can provide defined data structures for a client to request (e.g., using query 64) a resource from the plurality of resources 62a-62n and for the API query handler 58 to retrieve and return the requested resource in response to the query 64 (e.g., in the form of a result 66 that is responsive to the query 64).

In some instances, the query 64 can be a nested query that includes a plurality of requested API operations that are nested within each other. For example, the requested API operations can include or reference finite parameters that reference or require traversing multiple levels within a hierarchical data representation (e.g., a data graph).

The system memory 52 also includes a query handover service 68. The query handover service 68 can detect when the level of nesting associated with the query 64 becomes problematic (e.g., requires processing or other actions that exceed one or more predefined computational constraints). Specifically, the query handover service 68 can determine whether the query 64 satisfies one or more query computation constraints.

As one example, to determine whether the query 64 satisfies one or more query computation constraints, the query handover service 68 can evaluate a set of logic that evaluates one or more characteristics of the query 64 or processing operations associated with the query 64. For example, the query handover service 68 can determine whether a nesting level associated with the query exceeds a predetermined nesting value. For example, the predetermined nesting value can be set at an application layer or on a per-application basis. As one example, the query handover service 68 can increment a counter for each nested query or subquery. When the counter meets and/or exceeds the predetermined nesting value, the query handover service 68 can determine that the query 64 satisfies one or more query computation constraints.

As another example, the query handover service 68 can determine whether a memory usage associated with processing of the query 64 by the classical computing system 50 exceeds a predetermined usage value. For example, the query handover service 68 can evaluate an amount of memory associated with a current total return set of resources associated with current processing of the query 64. The query handover service 68 can determine whether the amount of memory associated with the current total return set of resources exceeds a predetermined usage value. When the amount of memory meets and/or exceeds the predetermined usage value, the query handover service 68 can determine that the query 64 satisfies one or more query computation constraints.

As another example, the query handover service 68 can determine when one of the requested API operations includes traversing a one-to-many relationship (e.g., a one-to-massive relationship) between the plurality of resources. In some implementations, if one of the requested API operations includes traversing a one-to-many relationship, then the query handover service 68 can determine that the query 64 satisfies one or more query computation constraints.

As yet another example, the query handover service 68 can evaluate other characteristics such as an identity of the client that provided the query 64, a current amount of available processing resources available to the classical computing system 50, a current load allocated to the classical computing system 50, current noise levels, and/or other computational or operational characteristics.

As mentioned above, the query handover service 68 can evaluate a set of logic that evaluates one or more of the characteristics described above and/or other characteristics. The logic can specify certain combination(s) of characteristic(s) or condition(s) that, when met, result in a determination by the query handover service 68 that the query 64 satisfies the one or more query computation constraints.

In some implementations, the query handover service 68 can evaluate whether the query computation constraint(s) are met prior to classical computing system 50 (e.g., the API query handler 58) performing processing of the query 64. This arrangement can reduce the number of instances where the API query handler 58 attempts, but ultimately fails to process the query 64.

In other implementations, the query handover service 68 can evaluate whether the query computation constraint(s) are met in parallel with and/or based upon processing of the query by the classical computing system 50 (e.g., by the API query handler 58). This arrangement can enable the API query handler 58 to at least attempt to perform the processing of the query 64 before handing processing over to the quantum computing system 10.

Referring still to FIG. 1, in response to determining that the query 64 satisfies the one or more query computation constraints, the query handover service 68 can generate a quantum instruction set 70 that enables the query 64 to instead be processed by the quantum computing system 10. Specifically, when the query handover service 68 detects that the query 64 is beyond the nested capability of the classical computing system 50, the query handover service 68 will failover to the quantum computing system 10, for example by passing the quantum instruction set 70. As examples, the quantum instruction set 70 can be a QASM file or other set of instructions in a quantum assembly language.

In particular, in some implementations, the query handover service 68 can map, within the quantum instruction set 70, the resources 62a-62n to qubits 18(0)-18(Q) of the quantum computing system 10. For example, the mapping can be a one-to-one mapping. As an example, the query handover service 68 can generate the mapping for the resources 62a-62n starting at the entry point of the query 64 (e.g., the highest level of nesting) and then proceed to map to all resources 62a-62n that are below the entry point of the query 64.

Furthermore, having each resource 62a-62n being mapped to one of the qubits 18(0)-18(Q) allows the query handover service 68 to encode an algorithmic mapping of the requested API logic from the query 64 into the quantum instruction set 70. In particular, the query handover service 68 can encode the logic from the query 64 into a number of execution steps within the quantum instruction set 70. As an example, the query handover service can generate one quantum execution step for each resource or object referenced by the query 64. For example, each execution step can identify a certain qubit that corresponds to a certain resource or object and can indicate an attribute, field, or property for which additional information is to be evaluated and/or returned. The execution steps in the quantum instruction set 70 can then be iteratively executed by the quantum computing system 10 to determine an optimal execution path 72.

By executing the quantum instruction set 70, the quantum computing system 10 can ultimately discover the energy minimum or optimal execution path 72 through the resources 62a-62n. In particular, using qubits 18(0)-18(Q) which have been placed into superposition enables the quantum computing system 10 to perform multiple computations simultaneously to determine the optimal execution path 72.

The execution path 72 discovered by the quantum computing system 10 can then be provided back to classical computing system 50 (e.g., the API query handler 58). The classical computing system 50 (e.g., the API query handler 58) can use the execution path 72 to determine a result 66 for the query 64. The classical computing system 50 (e.g., the API query handler 58) can return the result 66 to the client that submitted the query 64.

The quantum computing system 10 comprises a system memory 12 and a processor device 14. The quantum computing system 10 further comprises a persistent data store 16 (e.g., a hard drive or Solid State Drive (SSD), as non-limiting examples). It is to be understood that the quantum computing system 10 in some examples may include constituent elements in addition to those illustrated in FIG. 1. The quantum computing system 10 operates in quantum environments but is capable of operating using classical computing principles or quantum computing principles. Thus, in some implementations, portions of the quantum computing system 10 may be executed using classical computing components and/or algorithms.

When using quantum computing principles, the quantum computing system 10 performs computations that utilize quantum-mechanical phenomena, such as superposition and/or entanglement states. The quantum computing system 10 may operate under certain environmental conditions, such as at or near zero degrees (0°) Kelvin. When using classical computing principles, the quantum computing system 10 utilizes binary digits that have a value of either zero (0) or one (1).

In the example of FIG. 1, the quantum computing system 10 implements a set of one or more qubits 18(0)-18(Q) for use by quantum services executed by the quantum computing system 10. To maintain information for the qubit(s) 18(0)-18(Q), the quantum computing system 10 includes a qubit registry 20, which comprises a plurality of qubit registry entries 22(0)-22(R) each corresponding to a qubit such as the one or more qubits 18(0)-18(Q). The qubit registry 20 maintains and provides access to data relating to the qubits implemented by the quantum computing system 10, such as a count of the total number of qubits implemented by the quantum computing system 10 and a count of the number of available qubits that are currently available for allocation, as non-limiting examples. Each of the qubit registry entries 22(0)-22(R) of the qubit registry 20 also stores qubit metadata (not shown) for a corresponding qubit. The qubit metadata may include, as non-limiting examples, an identifier of the corresponding qubit, an availability indicator that indicates whether the corresponding qubit is available for use or is in use by a specific quantum service, an identifier of a quantum service that is associated with the corresponding qubit or to which the corresponding qubit is allocated, and/or an quantum phenomena indicator that indicates whether the corresponding qubit is in an entangled state and/or a superposition state.

The quantum computing system 10 of FIG. 1 executes one or more quantum services, such as the quantum service 24 and the quantum service 26. The quantum service 24 and the quantum service 26 are processes that employ qubits such as the one or more qubits 18(0)-18(Q) to provide desired functionality. Execution of quantum services such as the quantum service 24 and the quantum service 26 is facilitated by a quantum service manager 28 and a quantum service scheduler 30. The quantum service manager 28 of the quantum computing system 10 handles operations for creating, monitoring, and terminating quantum services, while the quantum service scheduler 30 of the quantum computing system 10 controls the scheduling of quantum services for execution by the processor device 14, and allocation of processing resources to executing quantum services. The functionality of the quantum service manager 28 and the quantum service scheduler 30 may be made accessible to other processes (e.g., via a defined application programming interface (API), as a non-limiting example).

It is to be understood that, because the query handover service 68 is a component of the classical computing system 50, functionality implemented by the query handover service 68 may be attributed to the classical computing system 50 generally. Moreover, in examples where the query handover service 68 comprises software instructions that program the processor device 54 to carry out functionality discussed herein, functionality implemented by the query handover service 68 may be attributed herein to the processor device 54. It is to be further understood that while, for purposes of illustration only, the query handover service 68 is depicted as a single component, the functionality implemented by the query handover service 68 may be implemented in any number of components, and the examples discussed herein are not limited to any particular number of components.

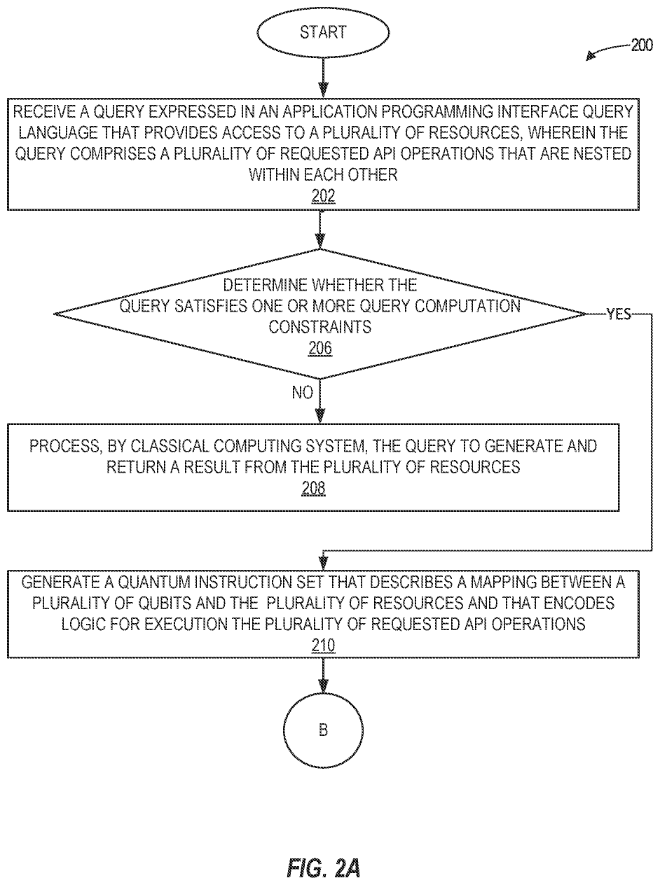

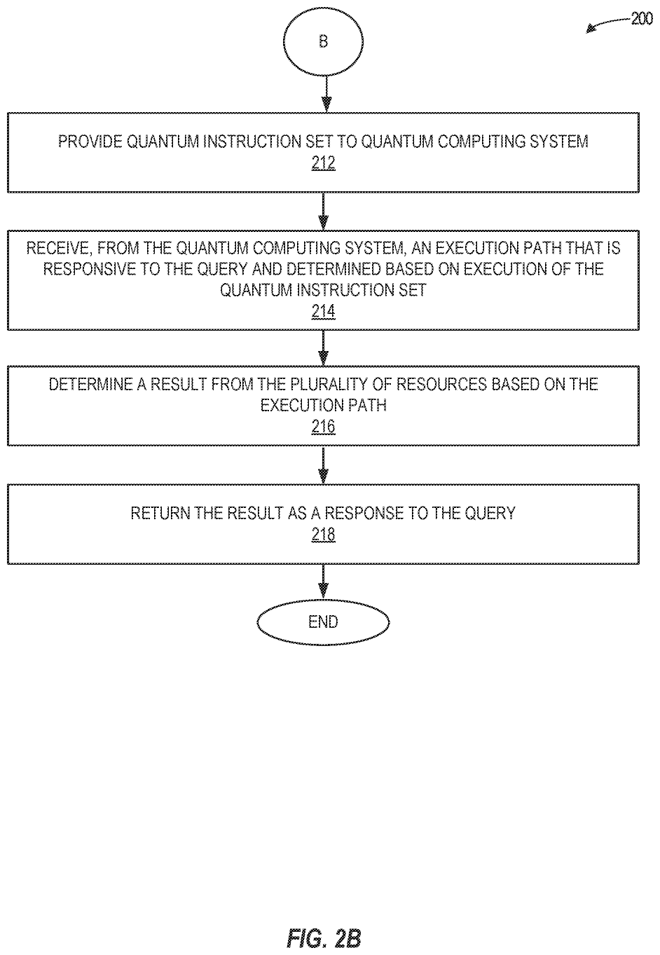

To illustrate exemplary operations performed by the classical computing system 50 of FIG. 1 for handover of deeply nested queries for quantum computing according to one example, FIGS. 2A and 2B provide a flowchart 200. Elements of FIG. 1 are referenced in describing FIGS. 2A and 2B for the sake of clarity.

In FIG. 2A, operations begin with a processor device of a computing device, such as the processor device 54 of the classical computing system 50 of FIG. 1. At 202, the processor device 54 receives a query 64 expressed in an API query language that provides access to a plurality of resources 62a-62n. The query 64 can include a plurality of requested API operations that are nested within each other. As an example, the API query handler 58 can receive the query 64 from a client.

The processor device 54 then determines whether the query 64 satisfies one or more query computing constraints at 206. As an example, the query handover service 68 can evaluate a set of logic that evaluates one or more characteristics of the query and/or ongoing computational or operational conditions. The logic can specify certain combination(s) of characteristic(s) or condition(s) that, when met, result in a determination by the query handover service 68 that the query 64 satisfies the one or more query computation constraints.

If it is determined at 206 that the query 64 does not satisfy one or more query computing constraints, then at 208 the processor device 54 processes the query 64 to generate and return a result 66 from the plurality of resources 62a-62n. For example, the API query handler 58 can process the query 64.

However, if it is determined at 206 that the query 64 does satisfy one or more query computing constraints, then at 210 the processor device 54 generates a quantum instruction set 70 that describes a mapping between a plurality of qubits 18(0)-18(Q) of a quantum computing system 10 and the plurality of resources 62a-62n. For example, the query handover service 68 can map the plurality of resources 62a-62n to the plurality of qubits 18(0)-18(Q) and can further encode an algorithmic mapping of the requested API logic from the query 64 into the quantum instruction set 70.

Referring now to FIG. 2B, the processor device 54 then at 212 provides the quantum instruction set 70 to the quantum computing system 10. The processor device 54 then at 214 receives, from the quantum computing system 10, an execution path 72 that is responsive to the query 64 and determined based on execution of the quantum instruction set 70.

The processor device 54 then at 216 determines a result 66 from the plurality of resources based on the execution path 72. For example, the API query handler 58 can use the execution path 72 to retrieve one or more of the resources 62a-62n. The processor device 54 then at 218 returns the result 66 as a response to the query 64.

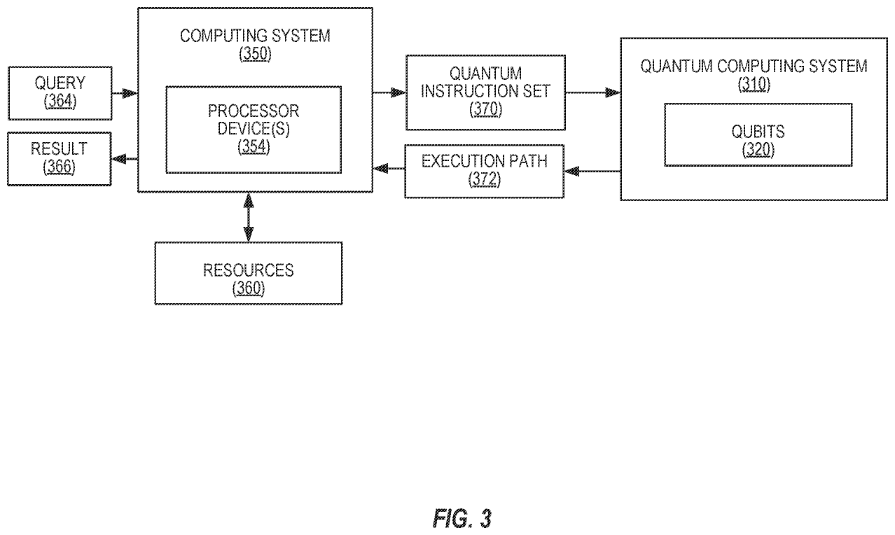

FIG. 3 is a simpler block diagram of the computing environment of FIG. 1 for handover of deeply nested queries for quantum computation, according to one example. In the example of FIG. 3, a computing system 350 includes one or more processing devices 354. The one or more processor devices 354 are to receive a query 364 expressed in an application programming interface (API) query language that provides access to a plurality of resources 360, wherein the query 364 comprises a plurality of requested API operations that are nested within each other. The one or more processor devices 354 are to determine whether the query 364 satisfies one or more query computation constraints. In response to the query 364 satisfying the one or more query computation constraints, the one or more processor devices 354 are to provide, to a quantum computing system 310 comprising a plurality of qubits 320, a quantum instruction set 370 that describes a mapping between the plurality of qubits 320 and the plurality of resources 360. The one or more processor devices 354 are to receive, from the quantum computing system 310, an execution path 372 that is responsive to the query 364 and determined based on execution of the quantum instruction set 370. The one or more processor devices 354 are to return, as a response to the query 364, a result 366 from the plurality of resources 360 based on the execution path 372 received from the quantum computing system 310.

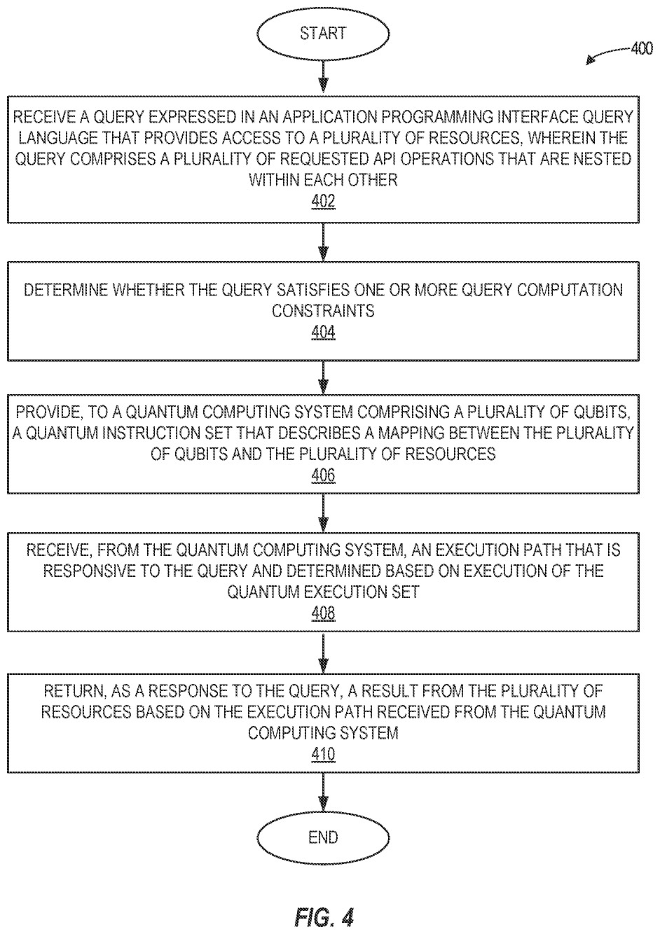

FIG. 4 provides a flowchart 400 of a simplified method for handover of deeply nested queries for quantum computation by the computing system 350 of FIG. 3, according to one example. For the sake of clarity, elements of FIG. 3 are referenced in describing FIG. 4.

Operations in FIG. 4 begin at 402. At 402, the one or more processor devices 354 of the computing system 350 receive a query 364 expressed in an application programming interface (API) query language that provides access to a plurality of resources 360, wherein the query 364 comprises a plurality of requested API operations that are nested within each other.

At 404, the one or more processor devices 354 of the computing system 350 determine whether the query 364 satisfies one or more query computation constraints.

At 406, in response to the query 364 satisfying the one or more query computation constraints, the one or more processor devices 354 of the computing system 350 provide, to a quantum computing system 310 comprising a plurality of qubits 320, a quantum instruction set 370 that describes a mapping between the plurality of qubits 320 and the plurality of resources 360.

At 408, the one or more processor devices 354 of the computing system 350 receive, from the quantum computing system 310, an execution path 372 that is responsive to the query 364 and determined based on execution of the quantum instruction set 370.

At 410, the one or more processor devices 354 of the computing system 350 return, as a response to the query 364, a result 366 from the plurality of resources 360 based on the execution path 372 received from the quantum computing system 310.

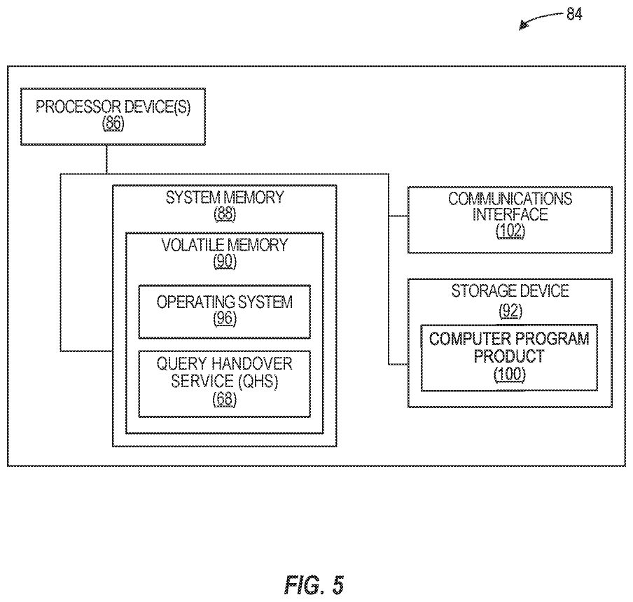

FIG. 5 is a block diagram of a computing device 84, suitable for implementing examples according to one example (e.g., suitable for implementing the classical computing system 50 of FIG. 1). The computing device 84 may comprise any suitable computing device or devices. The computing device 84 can operate using classical computing principles or quantum computing principles. When using quantum computing principles, the computing device 84 performs computations that utilize quantum-mechanical phenomena, such as superposition and entanglement. In such cases, the computing device 84 may operate under certain environmental conditions, such as at or near zero degrees (0°) Kelvin. When using classical computing principles, the computing device 84 utilizes binary digits that have a value of either zero (0) or one (1).

The computing device 84 includes one or more processor devices 86 and a system memory 88. The processor device(s) 86 can be any commercially available or proprietary processor suitable for operating in a quantum environment. The system memory 88 may include volatile memory 90 (e.g., random-access memory (RAM)). The computing device 84 may further include or be coupled to a non-transitory computer-readable medium such as a storage device 92. The storage device 92 and other drives associated with computer-readable media and computer-usable media may provide non-volatile storage of data, data structures, computer-executable instructions, and the like.

A number of modules can be stored in the storage device 92 and/or in the volatile memory 90, including an operating system 96 and one or more modules, such as a the query handover service 68 as described with reference to FIG. 1. All or a portion of the examples described herein may also be implemented as a computer program product 100 stored on a transitory or non-transitory computer-usable or computer-readable medium, such as the storage device 92, which includes complex programming instructions, such as complex computer-readable program code, to cause the processor device(s) 86 to carry out the steps described herein. Thus, the computer-readable program code can comprise computer-executable instructions for implementing the functionality of the examples described herein when executed on the processor device(s) 86.

An operator may also be able to enter one or more configuration commands through a keyboard (not illustrated), a pointing device such as a mouse (not illustrated), or a touch-sensitive surface such as a display device (not illustrated). The computing device 84 may also include a communications interface 102 suitable for communicating with other computing systems, including, in some implementations, classical computing devices and/or quantum computing systems.

Individuals will recognize improvements and modifications to the preferred examples of the disclosure. All such improvements and modifications are considered within the scope of the concepts disclosed herein and the claims that follow.

What is claimed is:

1. A computer-implemented method, comprising:
receiving a query expressed in an application programming interface (API) query language that provides access to a plurality of resources, wherein the query comprises a plurality of requested API operations that are nested within each other;
determining whether the query satisfies one or more query computation constraints; and
in response to the query satisfying the one or more query computation constraints:
providing, to a quantum computing system comprising a plurality of qubits, a quantum instruction set that describes a mapping between the plurality of qubits and the plurality of resources;
receiving, from the quantum computing system, an execution path that is responsive to the query and determined based on execution of the quantum instruction set; and
returning, as a response to the query, a result from the plurality of resources based on the execution path received from the quantum computing system.

2. The computer-implemented method of claim 1, wherein the API query language comprises GraphQL.

3. The computer-implemented method of claim 1, wherein determining whether the query satisfies one or more query computation constraints comprises determining whether a nesting level associated with the query exceeds a predetermined nesting value.

4. The computer-implemented method of claim 1, wherein determining whether the query satisfies the one or more query computation constraints comprises determining whether the query satisfies the one or more query computation constraints prior to any processing of the query by a classical computing system to attempt to return the result.

5. The computer-implemented method of claim 1, wherein determining whether the query satisfies the one or more query computation constraints comprises determining whether the query satisfies the one or more query computation constraints in parallel with and based upon processing of the query by a classical computing system to attempt to return the result.

6. The computer-implemented method of claim 5, wherein determining whether the query satisfies the one or more query computation constraints comprises determining when a memory usage associated with processing of the query by the classical computing system exceeds a predetermined usage value.

7. The computer-implemented method of claim 1, wherein determining whether the query satisfies the one or more query computation constraints comprises determining when one of the requested API operations comprises traversing a one-to-many relationship between the plurality of resources.

8. The computer-implemented method of claim 1, wherein the quantum instruction set comprises a QASM file.

9. The computer-implemented method of claim 1, wherein the quantum instruction set describes a one-to-one mapping between the plurality of qubits of the quantum computing system and the plurality of resources.

10. The computer-implemented method of claim 1, further comprising, in response to the query satisfying the one or more query computation constraints:
automatically generating the quantum instruction set by encoding the plurality of requested API operations of the API query language into the quantum instruction set.

11. The computer-implemented method of claim 1, further comprising:
executing, by the quantum computing system, the quantum instruction set to determine the execution path.

12. The computer-implemented method of claim 1, wherein:
relationships between the plurality of resources are structured according to a graph; and
the execution path traverses the graph.

13. The computer-implemented method of claim 1, wherein the plurality of resources comprise a plurality of data objects in a database.

14. A computer system, comprising:
one or more processor devices to:
receive a query expressed in an application programming interface (API) query language that provides access to a plurality of resources, wherein the query comprises a plurality of requested API operations that are nested within each other;
determine whether the query satisfies one or more query computation constraints; and
in response to the query satisfying the one or more query computation constraints:
provide, to a quantum computing system comprising a plurality of qubits, a quantum instruction set that describes a mapping between the plurality of qubits and the plurality of resources;
receive, from the quantum computing system, an execution path that is responsive to the query and determined based on execution of the quantum instruction set; and
return, as a response to the query, a result from the plurality of resources based on the execution path received from the quantum computing system.

15. The computer system of claim 14, wherein the API query language comprises GraphQL.

16. The computer system of claim 14, wherein to determine whether the query satisfies one or more query computation constraints the one or more processor devices are to determine whether a nesting level associated with the query exceeds a predetermined nesting value.

17. The computer system of claim 14, wherein to determine whether the query satisfies the one or more query computation constraints the one or more processor devices are to determine whether the query satisfies the one or more query computation constraints prior to any processing of the query by a classical computing system to attempt to return the result.

18. The computer system of claim 14, wherein to determine whether the query satisfies the one or more query computation constraints the one or more processor devices are to determine whether the query satisfies the one or more query computation constraints in parallel with and based upon processing of the query by a classical computing system to attempt to return the result.

19. The computer system of claim 14, wherein the one or more processor devices are further to, in response to the query satisfying the one or more query computation constraints:
automatically generate the quantum instruction set by encoding the plurality of requested API operations of the API query language into the quantum instruction set.

20. A non-transitory computer-readable storage medium that includes executable instructions to cause one or more processor devices to:
receive a query expressed in an application programming interface (API) query language that provides access to a plurality of resources, wherein the query comprises a plurality of requested API operations that are nested within each other;
determine whether the query satisfies one or more query computation constraints; and
in response to the query satisfying the one or more query computation constraints:
provide, to a quantum computing system comprising a plurality of qubits, a quantum instruction set that describes a mapping between the plurality of qubits and the plurality of resources;
receive, from the quantum computing system, an execution path that is responsive to the query and determined based on execution of the quantum instruction set; and
return, as a response to the query, a result from the plurality of resources based on the execution path received from the quantum computing system.
